(19) United States
(12) Patent Application Publication
(10) Pub. No.: US 2021/0101439 A1
(43) Pub. Date: Apr. 8, 2021

(54) MODULAR CLIMATE SYSTEM ENABLING FLEXIBLE MULTI-ZONE TEMPERATURE AND MODE CONTROL IN AUTOMOTIVE HVAC SYSTEMS

(71) Applicant: Ford Global Technologies, LLC, Dearborn, MI (US)

(72) Inventors: Robert Louis Hayes, Dearborn, MI (US); John Azar, LaSalle (CA); Trent Greear Sutherland, Dearborn, MI (US)

(73) Assignee: Ford Global Technologies, LLC, Dearborn, MI (US)

(21) Appl. No.: 16/595,874

(22) Filed: Oct. 8, 2019

(51) Int. Cl. B60H 1/00

(52) U.S. Cl. CPC B60H 1/00064; B60H 2001/00128; B60H 2001/00242; B60H 2001/002; B60H 2001/00942

(57) ABSTRACT

A multi-zone climate control system for vehicles includes a front HVAC unit and one or more additional units that can be configured to provide conditioned air to one or more rear climate zones. The front HVAC unit is adapted to condition air provided to at least one front climate zone. The front HVAC unit may include a cold air outlet that supplies cold air to an electrically-powered heater positioned in a console of the vehicle. The electrically-powered heater includes an electricity-to-air heat exchanger to control a temperature of conditioned air supplied to at least one rear zone of the passenger compartment. The system may include an auxiliary climate control system having an auxiliary heater core and an auxiliary evaporator positioned in a rear portion of the vehicle to provide conditioned air to one or more rear climate zones.

### FIELD OF THE INVENTION

The present invention generally relates to HVAC systems for motor vehicles, and in particular, to a modular HVAC system that can be reconfigured to provide conditioned (heated and cooled) air to multiple zones of various different vehicles.

### BACKGROUND OF THE INVENTION

Various types of heating ventilation and air conditioning (“HVAC”) systems have been developed for motor vehicles. Known systems may utilize coolant that has been heated by an internal combustion engine to heat air that is supplied to the passenger compartment. Vehicle HVAC systems may also include air conditioning systems to cool and/or dehumidify air that is supplied to the vehicle interior space.

### SUMMARY OF THE INVENTION

One aspect of the present disclosure is a vehicle having a passenger compartment with a front row of seats defining first and second front climate zones, a second row of seats behind the front row of seats defining at least one intermediate climate zone, and a third row of seats behind the second row of seats defining at least one rear climate zone. The vehicle includes a front HVAC unit mounted in a forward portion of the vehicle and including front air outlets that are configured to provide heated and cooled air to the first and second front zones. The front HVAC unit preferably includes a cold air outlet. An electrically-powered Positive Thermal Coefficient (PTC) heater is operably connected to the cold air outlet of the front HVAC unit to heat cold air from the cold air outlet. The electrically-powered PTC heater includes an electricity-to-air heat exchanger that is configured to selectively heat cold air entering the PTC heater. The electrically-powered PTC heater further includes a control system that is configured to control a temperature of air exiting the PTC heater. The electrically-powered PTC heater further includes at least one air outlet configured to supply heated air from the electrically-powered PTC heater to the at least one intermediate climate zone of the passenger compartment. The vehicle further includes an auxiliary climate control system that is configured to selectively heat and cool air exiting one or more air outlets positioned behind the intermediate zone in the rear zone. The auxiliary climate control system includes an auxiliary heater core and an auxiliary evaporator core. The auxiliary heater core and the auxiliary evaporator core are both positioned behind the intermediate row.

Embodiments of the first aspect of the disclosure can include any one or a combination of the following features:
The PTC heater may optionally include first and second zones that are configured to supply air to first and second portions of the rear zone.
The auxiliary climate control system may optionally include a first mode door downstream from the first zone of the auxiliary heater core, and a second mode door downstream from the second zone from the auxiliary heater core.
The auxiliary climate control system may include a blower that is configured to force air through the evaporator and the auxiliary heater core toward the first mode door and the second mode door.
The vehicle may include a powered blower that is fluidly connected to the cold air outlet and positioned in the center console behind the front HVAC unit.
The heat control system of the electrically-powered PTC heater may control electric current to electricity-to-air heat exchanger to control the temperature of air exiting the PTC heater.
The intermediate climate zone may include first and second intermediate climate zones, and the electrically-powered PTC heater may include first and second zones that separately heat air supplied to the first and second intermediate climate zones, respectively.
The system may include at least one plenum operably connected to the PTC heater to control flow of air from the at least one air outlet to at least one panel outlet of the at least one intermediate zone and at least one floor outlet of the at least one intermediate zone.
The electrically-powered PTC heater may be positioned in a center console rearward of the powered blower.
The vehicle may comprise an electrically powered vehicle including a high voltage traction battery that is positioned below a center console of the vehicle.
The vehicle may include a powertrain compartment in front of the passenger compartment.

Another aspect of the present disclosure is a vehicle having a passenger compartment defining at least first, second, and third rows, and a climate control system. The climate control system may include a front HVAC unit that is configured to be mounted in a forward portion of a vehicle. The front HVAC unit may be configured to provide conditioned air to one or more climate zones of the first row. The front HVAC unit may include a cold air outlet that provides only cold air. The vehicle may include a powered blower that is operably connected to the cold air outlet, and an electrically-powered heater that is connected to the cold air outlet of the front HVAC unit whereby cold air from the cold air outlet passes through the electrically-powered heater. The vehicle further includes left and right ducts extending from the electrically-powered heater. Left and right air outlets may be positioned behind the first row and connected to the left and right ducts to distribute air to left and right air side portions of the passenger compartment behind the first row. The vehicle further includes an auxiliary climate control system that is configured to selectively heat and cool air exiting one or more air outlets positioned behind the intermediate zone in the rear zone. The auxiliary climate control system includes an auxiliary heater core and an auxiliary evaporator core. The auxiliary heater core and the auxiliary evaporator core are both mounted behind the intermediate row.

Embodiments of the second aspect of the disclosure can include any one or a combination of the following features:
The left and right air outlets may be configured to direct air from the left and right ducts onto inner surfaces of left and right windows of the vehicle behind the first row.
The auxiliary climate control system may include ducts extending to air outlets positioned adjacent the second row of seats and to air outlets positioned adjacent the third row of seats.
The first, second, and third rows may comprise a single climate zone, and the climate control system may be configured to maintain a substantially uniform air temperature throughout the single climate zone.
The vehicle may include at least one mode door that is operably connected to the auxiliary heater core to control flow of air from the at least one air outlet to at least one panel outlet of the at least one rear zone and at least one floor outlet of the at least one rear zone.
The electrically-powered heater may comprise a PTC heater having an electricity-to-air heat exchanger.
The electricity-to-air heat exchanger may comprise a dual electricity-to-air heat exchanger having first and second electricity-to-air heat exchangers that are configured to independently heat first and second streams of air that are separated by a divider wall.

Another aspect of the present disclosure is a method of controlling air temperature in multiple zones of a passenger compartment of a motor vehicle. The method includes utilizing a front HVAC unit to provide independently-controlled conditioned air to first and second front zones of the passenger compartment. The method further includes causing cold air from the front HVAC unit to flow rearwardly through a center console of the motor vehicle to an electrically-powered heater that is disposed in the center console. An electricity-to-air heat exchanger of the heater is used to heat the cold air from the front HVAC unit. Air that has been heated by the electricity-to-air heat exchanger is distributed to a first rear zone of the passenger compartment. The first rear zone is located behind the first and second front zones of the passenger compartment. The method further includes utilizing an auxiliary climate control system having an auxiliary heater core and an auxiliary evaporator core. The auxiliary heater core and the auxiliary evaporator core are located behind the first rear zone to supply conditioned air to a second rear zone that is located behind the first rear zone. The method may optionally include causing cold air exiting the front HVAC unit to be distributed to the first rear zone without further cooling of the cold air after the cold air has exited the front HVAC unit.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a partially schematic side elevational view of a vehicle including a multi-zone climate control system according to one aspect of the present disclosure;

FIG. 1A is a schematic showing a front HVAC unit according to one aspect of the present disclosure;

FIG. 2 is a partially schematic cross-sectional view of the motor vehicle of FIG. 1 taken along the line II-II;

FIG. 3 is a partially schematic fragmentary isometric view of a portion of the vehicle of FIG. 1;

FIG. 4 is a schematic plan view of a motor vehicle having three climate zones;

FIG. 5 is a schematic plan view of a motor vehicle having four climate zones;

FIG. 6 is a schematic view of a single zone liquid-to-air heater core;

FIG. 7 is a schematic view of a dual zone liquid-to-air heater core;

FIG. 8 is a schematic view of a single zone heater having a blend door;

FIG. 9 is a schematic view of a dual zone heater having two blend doors;

FIG. 10 is a partially schematic side elevational view of a vehicle including a multi-zone climate control system according to another aspect of the present disclosure;

FIG. 10A is a schematic view of a single zone Positive Thermal Coefficient (PTC) heater including electricity-to-air heat exchanger;

FIG. 10B is a schematic view of a dual zone Positive Thermal Coefficient (PTC) heater including electricity-to-air heat exchanger;

FIG. 11 is a schematic plan view of a motor vehicle including a multi-zone climate control system according to another aspect of the present disclosure;

FIG. 12 is a schematic plan view of a motor vehicle including a multi-zone having an auxiliary climate control system for a third row of seats according to another aspect of the present disclosure;

FIG. 13 is a schematic plan view of a motor vehicle including a multi-zone having an auxiliary climate control system for a third row of seats according to another aspect of the present disclosure;

FIG. 14 is a schematic plan view of a motor vehicle including a multi-zone having an auxiliary climate control system for a third row of seats according to another aspect of the present disclosure;

FIG. 15 is a schematic plan view of a motor vehicle including a multi-zone having an auxiliary climate control system for rows two and three according to another aspect of the present disclosure; and

FIG. 16 is a schematic plan view of an autonomous vehicle including a climate control system according to another aspect of the present disclosure.

### DETAILED DESCRIPTION OF THE PREFERRED EMBODIMENTS

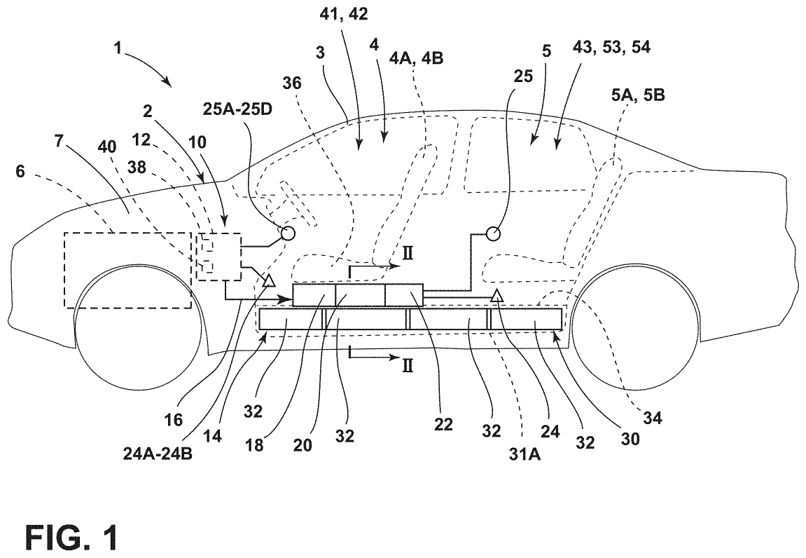

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present application is related to United States Patent Application No. ______ entitled “COMPACT DUAL-ZONE CONSOLE HVAC SYSTEM FOR AUTOMOBILES,” (Attorney Docket No. 84160657), filed on even date herewith, the entire contents of which are incorporated herein by reference. The present application is also related to U.S. patent application Ser. No. 16/360,773, filed on Mar. 21, 2019, and entitled “DUAL ZONE AUXILIARY CLIMATE CONTROL SYSTEM FOR A VEHICLE,” the entire contents of which are incorporated herein by reference.

With reference to FIGS. 1-3, a motor vehicle 1 according to one aspect of the present disclosure includes a body structure 2 and a passenger compartment/interior space 3. Vehicle 1 includes a front row of seats 4 including front seats 4A and 4B, and a rear row of seats 5 including rear seats 5A and 5B. Vehicle 1 further includes an engine 6 to provide for powered movement of the motor vehicle 1. Engine 6 may comprise an electric motor, an internal combustion engine, or a combination of electric and internal combustion engines (e.g., a hybrid engine system). Although engine 6 is shown schematically as a single unit in a forward portion 7 (e.g., a powertrain compartment) of vehicle 1, it will be understood that engine 6 may comprise, for example, a plurality of electric motors that are positioned in different locations of vehicle 1.

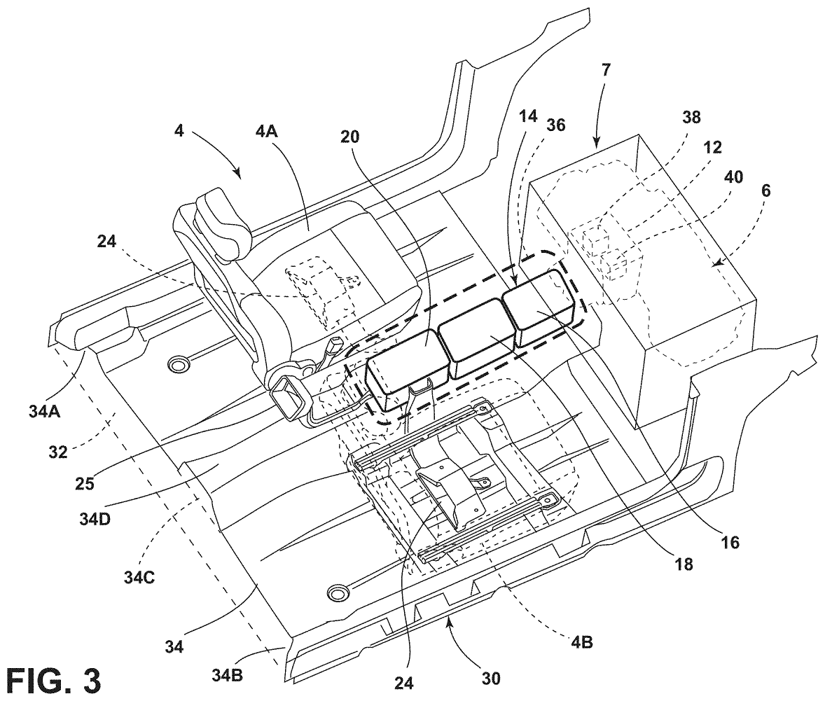

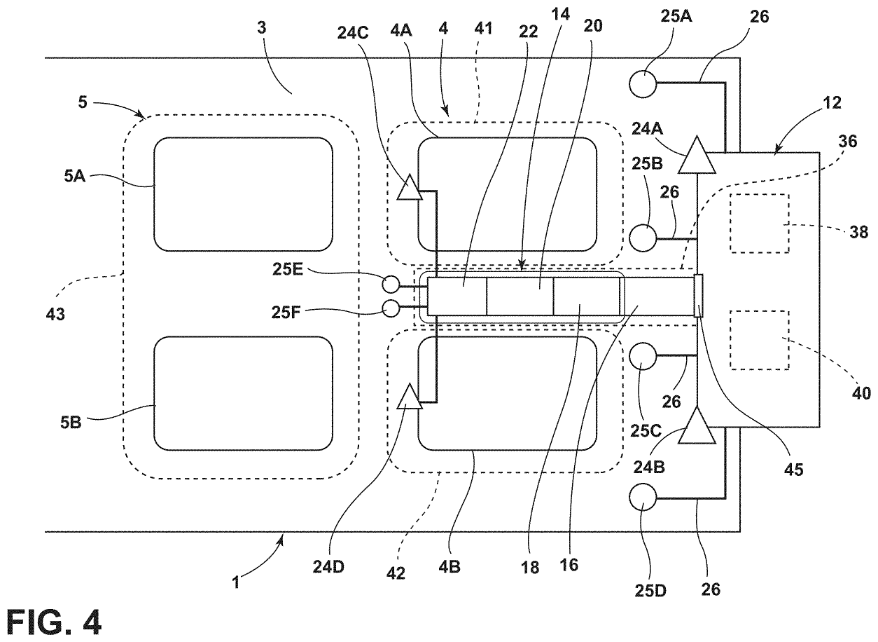

Vehicle 1 further includes a multi-zone HVAC system 10 that includes a front HVAC system or unit 12 mounted in a forward portion of vehicle 1 to supply conditioned air to front zones 41 and 42 corresponding to front seats 4A and 4B, respectively. As discussed in more detail below, front HVAC unit 12 may include a heating unit 38 and a cooling unit 40. Vehicle 1 further includes an auxiliary console HVAC system 14 that supplies conditioned air to a single rear zone 43 (FIG. 4) or two rear zones 53 and 54 (FIG. 5) corresponding to rear seats 5A and 5B, respectively. Each zone may (optionally) include a user input located in or adjacent the zone to permit users to input temperature control requests or commands. Each zone may also (optionally) include a temperature sensor that provides input to a controller to provide closed loop temperature control. As discussed in more detail below, the auxiliary console HVAC system 14 receives cold air from front HVAC unit 12 via a cold air duct 16 and provides conditioned (heated and/or cooled) air to one or more zones heated rearwardly of the front row 4. An optional blower 18 causes the cold air from cold air duct 16 to flow through a heater 20, and an air distribution unit such as a mode door assembly 22 selectively directs the conditioned air to one or more lower (e.g., floor) outlets 24 and/or upper (e.g., panel) outlets 25 to thereby provide conditioned air to the rear row 5 of vehicle 1. As discussed in more detail below, the heater 20 may be turned off (deactivated) such that cold air duct 16 passes through to the floor and panel outlets 24 and 25 to provide cool air to the rear row 5. Alternatively, the heater 20 may heat the cold air from cold air duct 16 a selected amount whereby the temperature of air supplied to the floor and panel outlets 24 and 25, respectively, can be controlled through a range of cold to warm as required or requested by passengers in the rear row 5 and/or additional rear zones (not shown).

With further reference to FIG. 1A, the front HVAC unit 12 may include an air inlet 74 that intakes ambient air 75. The heating unit 38 may comprise a fluid to air heat exchanger 76 that is disposed in air passageway 77, whereby air 75 entering air inlet 74 flows through the fluid air heat exchanger 76. The heat exchanger 76 may be fluidly connected to a source 80 of heated liquid. In the illustrated example, the heat source 80 comprises a radiator of an internal combustion engine that is positioned adjacent to a condenser 82 of cooling system 40 such that air 81 entering an inlet 83 flows through condenser 82 and radiator 80 to thereby heat liquid (e.g., coolant) flowing through lines 78 and 79. However, heat source 80 may comprise an electrically-powered heater such as a Positive Thermal Coefficient (“PTC”) heater that heats liquid (e.g., coolant) supplied to heat exchanger 76. Alternatively, heat exchanger 76 may be electrically heated directly by an electric heating element that is thermally connected to heat exchanger 76 by a thermally conductive material (e.g., metal) such that liquid is not required to transfer heat from a remote source. It will be understood that the heat exchanger 76 could be configured to receive heat from multiple sources (e.g., direct electric heat and a remote liquid heat source 80).

Cooling system 40 includes a compressor 84 that compresses refrigerant that flows through line 85 to condenser 82. Refrigerant exiting condenser 82 flows through line 86 to an expansion valve 87, and through line 88 to an evaporator core 89. Refrigerant flows from evaporator core 89 through a line 90 to the compressor 84. Air 75 flowing through passage 77 flows through evaporator core 89 to thereby cool and dehumidify the air, and the air then flows through the heat exchanger 76. The flow of fluid through the lines 78 and 79 may be controlled by a valve (not shown) in a known manner to thereby selectively heat the air a desired amount. Alternatively, the HVAC unit 12 may be configured to mix air that has been heated by heat exchanger 76 with air that has been cooled by the evaporator core 89 utilizing blend doors (not shown). The conditioned air is then directed to selected outlets 24 and 25 by a mode door unit 72 as required for a particular application. The basic operation of the heater 38 and A/C unit 40 are known, such that a more detailed description is not believed to be required.

The front HVAC unit 12 may include an auxiliary air passage 77A that receives a portion 75A of the incoming air and diverts the air along a secondary passageway 74A. The air 75A flowing through secondary passageway 77A flows through the evaporator core 89 whereby the air 75A is cooled to provide cooled air 75B that flows through a downstream portion 74B of the auxiliary air passageway 74A. The cooled air 75B exits into cold air duct 16 at cold air outlet 45. In the illustrated example, the auxiliary air passageway 77A is not operably connected to the heat exchanger 76 of heating unit 38 such that the air flowing out of cold air outlet 45 cannot be heated. It will be understood that numerous ways to provide a cold air outlet 45 are possible, and the arrangement of FIG. 1A is merely an example of a possible configuration.

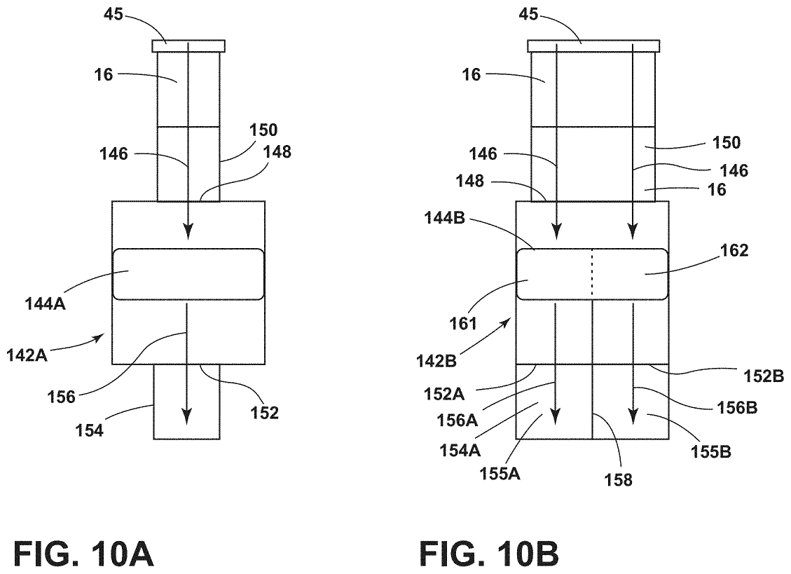

Condenser 82 of front HVAC unit 12 may be operably connected to an optional auxiliary climate unit or system 110 by refrigerant lines 86A and 90A. As discussed below in connection with FIGS. 10-16, auxiliary climate system 110 may be located in a rear portion of a vehicle.

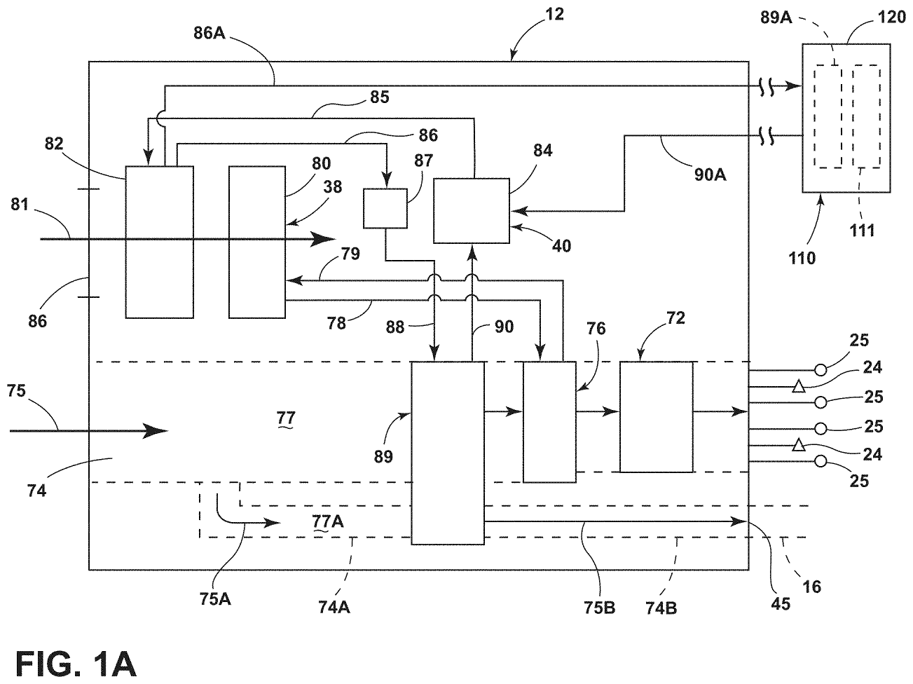

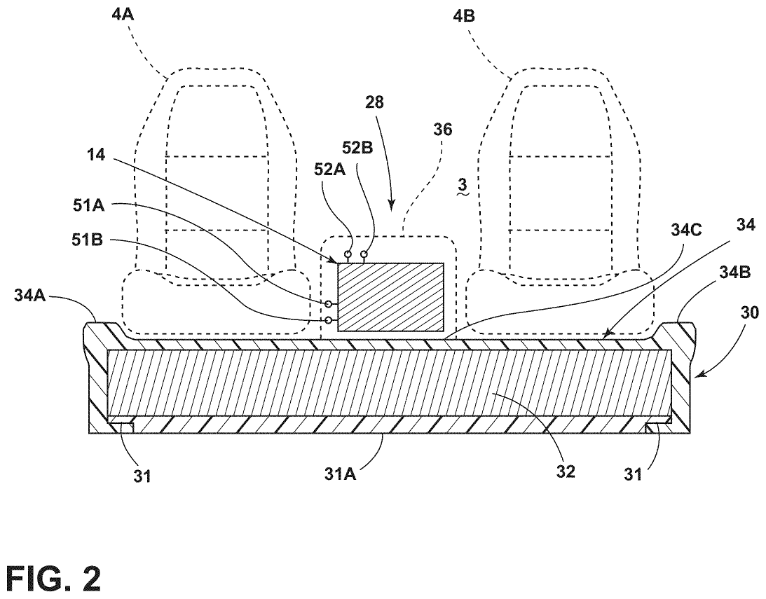

If vehicle 1 comprises an electrically-powered vehicle, the vehicle may include a floor structure 30 (FIG. 2) that supports batteries 32 (traction batteries) below a floorboard 34. Floor structure 30 may include battery support structure 31 that may include a lower pan or cover 31A that extends below the batteries 32. Vehicle 1 may include a center console 36 that extends fore-aft in a central portion 28 of the vehicle 1. The auxiliary console HVAC system 14 may be disposed at least partially within the console 36 between left and right front seats 4A and 4B, respectively. Floorboard 34 may extend continuously across the vehicle 1, with left and right edge portions 34A and 34B, and a central portion 34C disposed below the auxiliary console HVAC unit 14 and center console 36. Thus, the floorboard 34 may be configured to separate (isolate) the auxiliary console HVAC unit 14 from the batteries 32 positioned below the floorboard 34. Floorboard 34 may optionally include a raised center portion 34D (FIG. 3). If vehicle 1 is configured in this way, the console unit 14 may be positioned above the raised center floorboard portion 34D above batteries 32.

With further reference to FIG. 4, the front HVAC unit 12 may be configured to supply conditioned air to individual floor outlets 24A-24B and individual panel outlets 25A-25D via ducts 26. As discussed in more detail below in connection with FIG. 4A, the front HVAC system 12 may include a heating unit 38 and a cooling (AC) unit 40 that supply conditioned air at a desired temperature to the front outlets 24A-24B, and 25A-25D. The left front seat 4A may define a first front zone 41, and the seat 4B may define a second front zone 42. The outlets 24A, 25A, and 25B supply conditioned air to the first front zone 41, and the outlets 24B, 25C, and 25D provide air to the second front zone 42. In general, the temperature of the air supplied to the first and second front zones 41 and 42 can be individually controlled. For example, the front HVAC unit 12 may include blend doors (not shown) to provide a mixture of cold and warm air from heating unit 38 and AC unit 40 to the front outlets 24 and 25 in a manner that is generally known. Alternatively, an amount of heat supplied by heating unit 38 to air that has been cooled by AC unit 40 may be adjusted to control the temperature of air supplied to front outlets 24 and 25.

Cold air outlet 45 of front HVAC unit 12 is fluidly connected to cold air duct 16. The cold air outlet 45 preferably provides only cold air from AC unit 40 to the cold air duct 16. An optional blower motor unit 18 is fluidly connected to the cold air duct 16 to cause the cold air from front HVAC unit 12 to flow into heater 20. The heater 20 of FIG. 4 comprises a single zone heater core. Thus, substantially all of the air entering heater 20 is heated to the same temperature (if heater 20 is actuated), and the heated (conditioned) air is then supplied to the mode door assembly 22 and distributed to floor outlets 24C and 24D and panel outlets 25E and 25F. The mode door assembly 22 is configured to distribute the flow of air to the floor outlets 24C and 24D and the panel outlets 25E and 25F. For example, the mode door assembly 22 may be adjusted by a user such that substantially all of the air from heater 20 flows through the floor outlets 24C and 24D, or the mode door may be adjusted to cause substantially all of the air to flow through the panel outlets 25A and 25F. The mode door assembly 22 may also be adjusted to distribute the air through the floor outlets 24C and 24D and simultaneously through the panel outlets 25E and 25F. Rear seats 5A and 5B may together define a third or rear zone 43. It will be understood that the first and second rear seats 5A and 5B may comprise portions of a single rear bench seat, or separate seating units.

With further reference to FIG. 5, vehicle 1 may alternatively be configured with third and fourth zones 53 and 54, respectively, corresponding to the first and second rear seats or seating areas 5A, 5B, respectively. The HVAC system 14A of FIG. 5 is substantially similar to the system 14 of FIG. 4 except that the system 14A includes a dual zone heater 20A and a dual mode door unit 22A. As discussed in more detail below, the dual zone heater 20A is configured to independently heat air supplied to third and fourth zones 53 and 54, and the mode door unit 22A is configured to provide for independent control of the air in third and fourth zones 53 and 54. Thus, the system 14A permits the temperature of third zone 53 to be controlled independently of fourth zone 54, and the flow of air to the floor and panel outlets 24C, 24D, 25E, and 25F can also be independently controlled. It will be understood that the temperature control for the first and second zones 41 and 42 of FIG. 5 is controlled in substantially the same manner as the first and second zones 41 and 42 of FIG. 4.

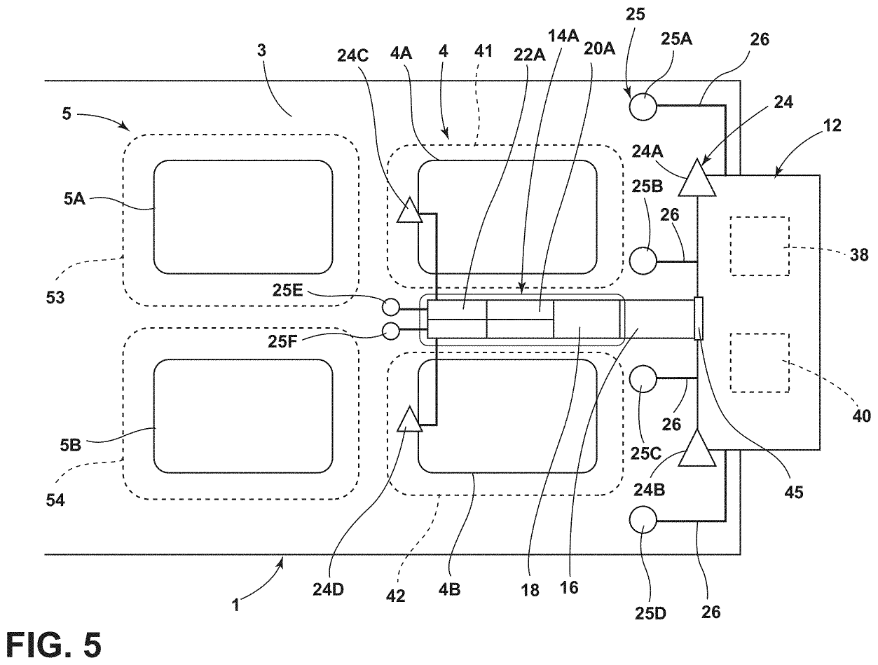

With further reference to FIG. 6, a single zone heater 20 may include a heater core comprising a liquid-to-air heat exchanger 48 that is connected to a source 50 of heated liquid by lines 51A and 51B. Source 50 may comprise a heat source 80 (FIG. 1A0 of front HVAC unit 12 or an electric heater that heats liquid (e.g., coolant), or source 50 may comprise an internal combustion engine (e.g., a conventional radiator) that heats liquid coolant. If vehicle 1 comprises an electrically-powered vehicle, the source 50 may comprise a high voltage PTC heater that is located in the powertrain compartment 7 and the lines 51A and 51B may be routed inside console 36 (see, e.g., FIG. 2). Similarly, if engine 6 comprises an internal combustion engine, the lines 51A and 51B may also be located in center console 36. Cold air 17 from outlet 45 of front HVAC unit 12 is heated as it flows through the heat exchanger 48, and conditioned (heated) air 21 is supplied to the mode door assembly 22. The heater 20 may be deactivated such that cold air 17 flows through the heater 20 without being heated. Also, the amount of heat supplied to the cold air 17 may be adjusted to thereby control the temperature of the conditioned air 21 exiting the heater 20. In particular, the volume of hot coolant received by the heat exchanger 48 from line 51A can be controlled by a powered valve 55 or other suitable arrangement. Alternatively, the temperature of the coolant flowing through line 51A can be controlled. For example, if source 50 comprises an electric heater, the amount of electricity supplied to heater 20 can be controlled to thereby control the temperature of the coolant exiting source 50. It will be understood that both the volume and temperature of coolant supplied to line 51A may be varied to thereby control the temperature of the heated air 21 exiting the heater 20.

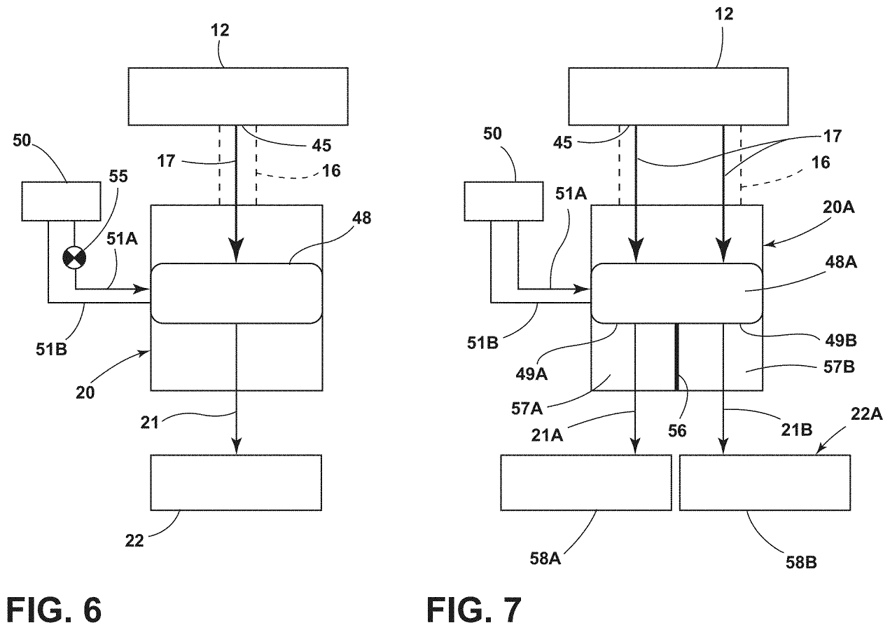

With further reference to FIG. 7, a dual zone heater core 20A includes a dual zone liquid-to-air heater core comprising a heat exchanger 48A having second heater cores 49A and 49B that are separately controlled to thereby heat air exiting the heat exchanger 48A independently. Specifically, the dual zone heater 20A receives cold air 17 in cold air duct 16, and includes first and second outlets 57A and 57B that are separated by a divider 56, and the conditioned (heated) air 21A and 21B exiting the first and second heater core sections 49A and 49B may be heated to different temperatures. Thus, separate streams 21A and 21B are supplied to first and second portions 58A and 58B of dual mode door assembly 22A. As discussed above in connection with FIG. 5, the dual zone mode door unit 22A is configured to separately control the flow of air to the outlets 24 and 25 of third and fourth zones 53 and 54.

Alternatively, the heaters 20 and/or 20A of FIGS. 6 and 7, respectively, may comprise electrically-powered electric-to-air PTC heating units rather than liquid-to-air heat exchangers. The heater 20A (FIG. 7) may comprise separately controlled PTC heaters. The electric current supplied to the PTC heating units may be adjusted to control the temperature of air 21, 21A, 21B exiting the heaters 20 and/or 20A.

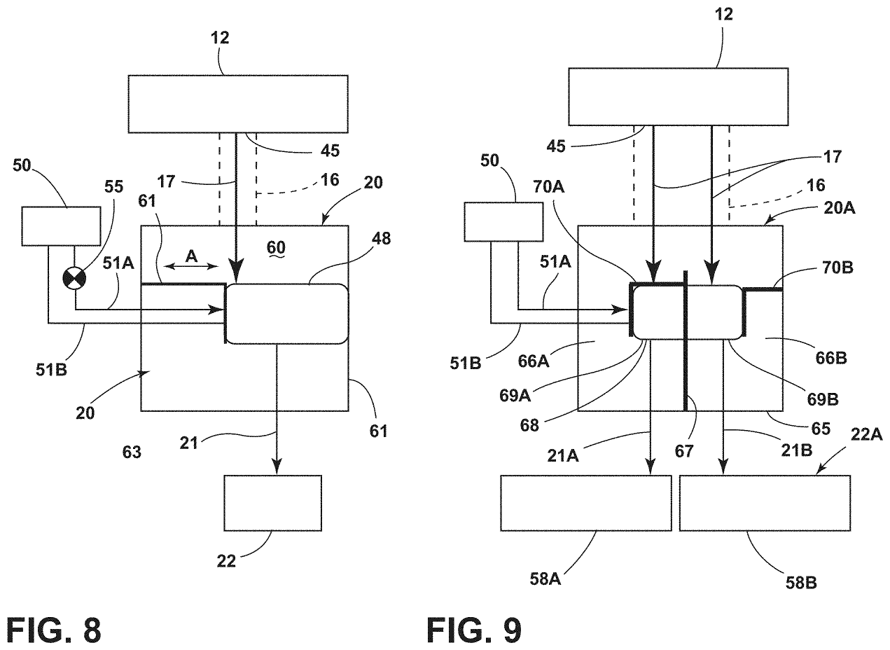

With further reference to FIG. 8, a single zone heater 20 according to another aspect of the present disclosure includes a single zone heat exchanger 48 that may operate in substantially the same manner as the heater core 48 discussed above in connection with FIG. 6. The heater 20 receives cold air 17 from cold air outlet 45 through cold air duct 16, and the cold air enters an interior space 60 of housing 61 of heater 20. The air flow through the interior space 60 is controlled by a blend door 62 that can be shifted as shown by the arrow “A” to selectively divert the air through a bypass 63 or through heater core 48. In general, the position of the blend door 62 can be adjusted to cause all of the cold air 17 to flow through bypass 63. Alternatively, the blend door 62 can be positioned to completely block the bypass 63, thereby causing all of the cold air 17 to flow through the heater core 48 to heat the air. The blend door 62 may also be configured to allow some of the air to flow through heater core 48 and through bypass 63 to thereby partially heat the cold air 17. Blend door 62 may be operably connected to a powered actuator (not shown) in a known manner. In FIG. 8, blend door 62 is shown as being a sliding blend door 62 that translates in a linear manner. However, blend door 62 may comprise a rotating or pivoting blend door of a known type. Heated air 21 exiting the heater 20 is supplied to mode door assembly 22 in a manner that is substantially similar to the arrangement discussed above in connection with FIG. 6.

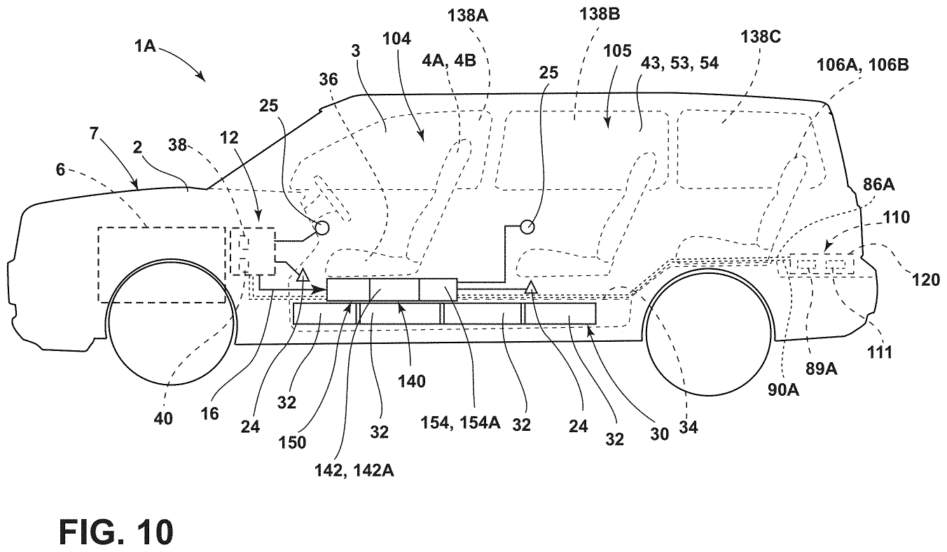

With further reference to FIG. 9, a dual zone heater 20A according to another aspect of the present disclosure includes a housing 65 having bypass areas 66A and 66B with a divider 67 disposed between the bypass areas 66A and 66B. A dual zone heater core 68 includes first and second portions 69A and 69B that may be independently controlled in a manner that is substantially similar to the arrangement of FIG. 7 discussed above. The blend doors 70A and 70B selectively control the flow of air through the heater core sections 69A and 69B and through the bypass areas 66A and 66B to thereby control the temperature of conditioned air 21A and 21B exiting the dual zone heater 20A. The heated air 21A and 21B is supplied to mode door assembly 22A in a manner substantially similar to the arrangement discussed above in connection with FIG. 7.

The console heaters 20 and/or 20A may include liquid-to-air heat exchangers as discussed above. Alternatively, the console heaters 20 and/or 20A may comprise electric-to-air heaters (e.g. PTC heaters) as discussed in more detail below in connection with FIGS. 10A and 10B.

With further reference to FIG. 10, a motor vehicle 1A according to another aspect of the present disclosure may include a front HVAC system or unit 12 mounted in a forward portion of vehicle 1A. HVAC unit 12 may be substantially similar to the front HVAC unit 12 described in more detail above in connection with FIGS. 1-9. The vehicle 1A may, optionally, include an auxiliary console HVAC system 140 including an electrically-powered PTC heater 142A (FIG. 10A) having a single zone, or a dual zone PTC heater 142B (FIG. 10B). As discussed in more detail below, PTC heaters 142A and 142B including electricity-to-air heat exchangers 144A, 144B, respectively, that may be configured to receive cold air from HVAC unit 12 and heat the air to provide conditioned air to one or more rear zones. The vehicle 1A may, optionally, include a floor structure 30, battery support structure 31, and batteries 32 that are substantially identical or similar to the corresponding components described in more detail above in connection with FIGS. 1-9. Still further, the vehicle 1A may include a power plant/engine 6 comprising an electric motor, an internal combustion engine, or a combination (e.g., hybrid) system.

Vehicle 1A includes a first row of seats 104, a second row of seats 105, and an optional third row of seats 106. The first row of seats 104 may be identical or similar to front row of seats 4 of vehicle 1 (FIG. 1), and the second (intermediate) row of seats 105 may be substantially similar to rear row of seats 5 of vehicle 1 (FIG. 1). As discussed in more detail below, vehicle 1A may optionally include an auxiliary climate system 110 to control additional zones such as one or more zones of third row of seats 106. The auxiliary climate system 110 may be substantially identical to the dual zone auxiliary climate control system described in U.S. pending application Ser. No. 16/360,773, which is incorporated herein by reference. The auxiliary climate system 110 may include a liquid-to-air heater core as described in the above-referenced application Ser. No. 16/360,773 in any of the configurations described herein (e.g., FIGS. 10-16). Alternatively, auxiliary climate system 110 may comprise an electricity-to-air PTC heater (e.g. single or dual zone) in any of the configurations described herein (e.g., FIGS. 10-16).

As discussed in more detail below, the climate systems 10, 140, and 110 may be utilized in various combinations to provide specific multi-zone climate zone configurations as may be required for variations of a particular model of vehicle. The climate systems 10, 140, and 110 may also be utilized in various combinations to provide specific multi-zone climate control for different models of vehicles. As also discussed below, the specific configuration of the HVAC systems 10, 140, and 110 may also be varied to provide the required number and location of climate zones for variations within a model line of a vehicle and/or for different models of vehicles. Thus, various combinations and variations of the HVAC systems 10, 140, and 110 can be utilized to provide a large number of different climate control configurations as may be required for a particular type and model of vehicle.

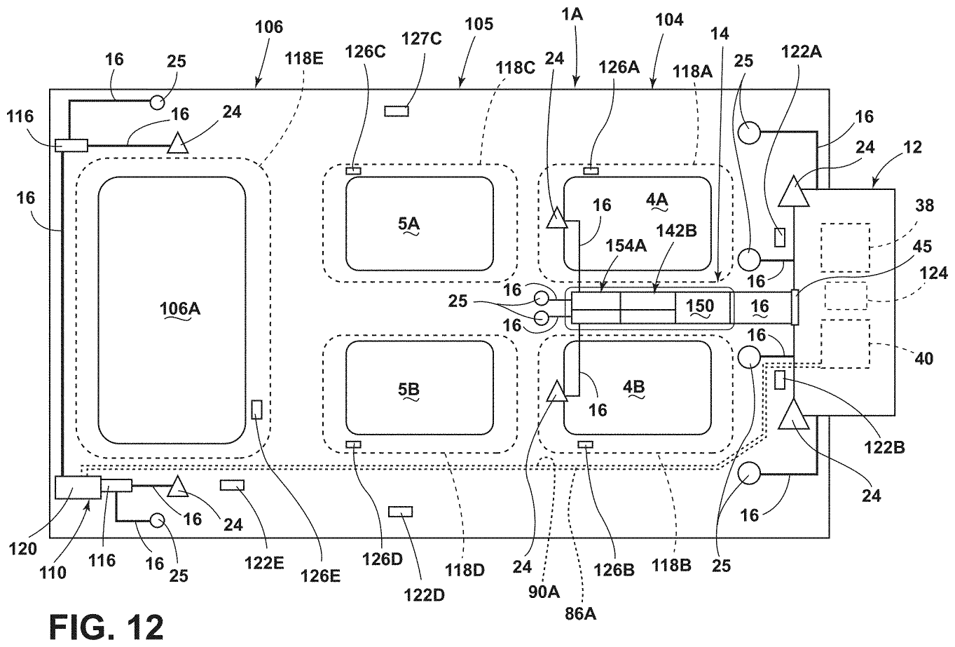

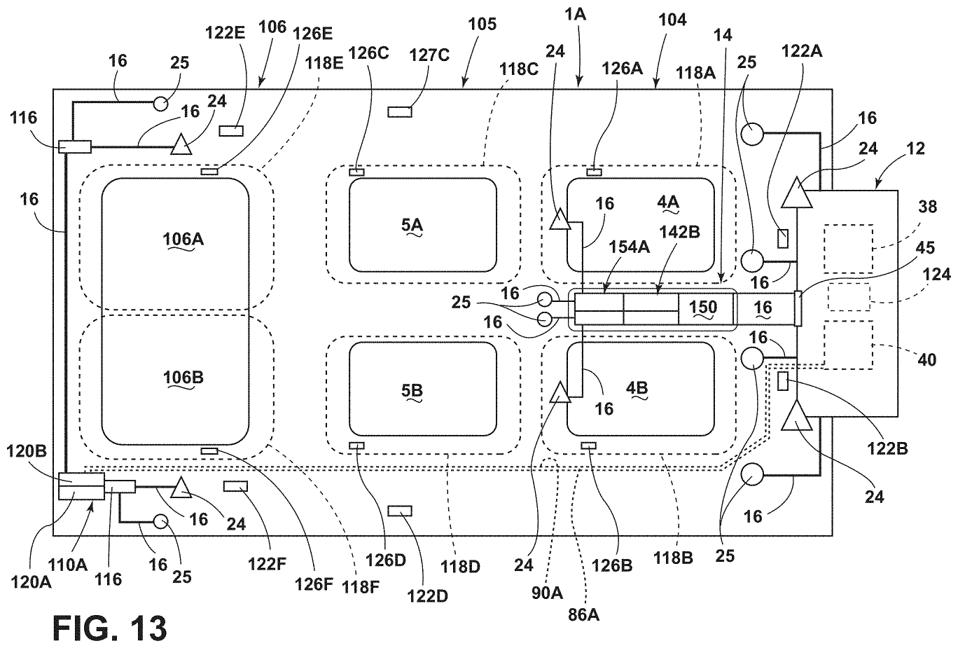

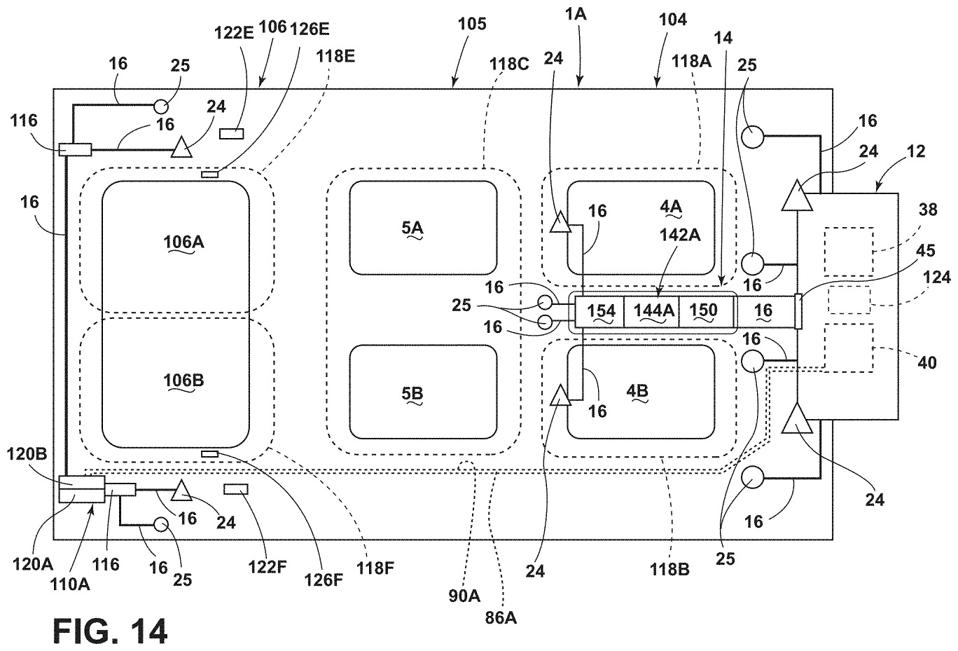

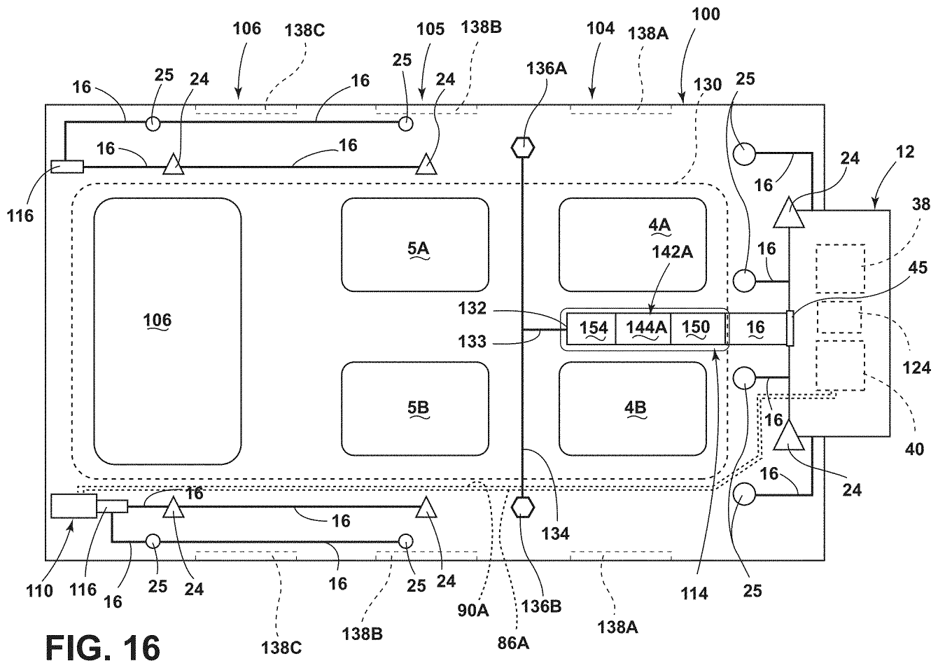

With further reference to FIGS. 10A and 10B, the HVAC system 140 may comprise a single zone PTC heating unit 142A (FIG. 10A) or a dual zone PTC unit 142B (FIG. 10B). The PTC units 142A and 142B may comprise either high voltage (e.g., 400V -800V) or low voltage (e.g., 12V) electricity-to-air heat exchangers 144A, 144B, respectively, that utilize electricity to heat a solid material of an electricity-to-air heat exchanger whereby cold air 146 received from cold air outlet 45 of front HVAC unit 12 is heated as it flows over the heated solid material. If the system is used in an electrically-powered vehicle, the PTC heater is preferably a high voltage PTC heater (provided a high voltage source of power is available). For vehicles that do not have a high voltage power source, a low voltage PTC heater is preferred. As discussed in more detail below, the single zone PTC system 142A may be utilized in a vehicle as configured in FIGS. 14 and 16, and the dual zone PTC heater 142B may be utilized in vehicles as configured in FIGS. 12 and 13.

Referring again to FIG. 10A, the single zone PTC heater 142A may include an inlet 148 that is operably connected to an optional console blower 150 that draws air through duct 16 from cold air outlet 45 of front HVAC unit 12. The single zone PTC heater 142A also includes an outlet 152 that supplies conditioned air 156 to a plenum 154 to distribute air to one or more outlets 24 and 25 (see also FIGS. 14 and 16). Single zone PTC heater 142A includes an electricity-to-air heat exchanger 144A that heats cold air 146 flowing through PTC heater 142A.

Referring to FIG. 10B, dual zone PTC unit 142B includes an electricity-to-air heat exchanger 144B having a first heat exchanger portion 161 and a second heat exchanger portion 162. The first and second heat exchanger portions 161 and 162 may be separately controlled to selectively heat cold air 146 and provide separate streams of conditioned air 156A and 156B exiting the dual zone PTC unit 142B. Cold air 146 from outlet 45 of front HVAC unit 12 is supplied to inlet 148 via air duct 16 and optional blower 150. The dual zone PTC unit 142B includes a divider wall 158 that separates the streams of conditioned air 156A and 156B to thereby maintain separate temperatures thereof. The air 156A and 156B exits through separate exits 152A and 152B, respectively, into a plenum 154A having separate internal compartments 155A and 155B, respectively. As discussed in more detail below, the dual zone PTC unit 142B may be utilized in vehicles as configured in FIGS. 12 and 13.

The PTC heating units 142A and 142B of FIGS. 10A and 10B, respectively, heat the cooled air 146 utilizing electricity-to-air heat exchangers 144A and 144B, respectively, such that heated liquid or the like is not required. The electricity (e.g., electrical current) supplied to the PTC heaters 142A and 142B can be directly controlled (varied) to thereby control the amount of heat added to the cold air 146. Thus, the PTC heaters 142A and 142B do not require air mixing or “blending” and the PTC heaters 142A and 142B do not include blend doors.

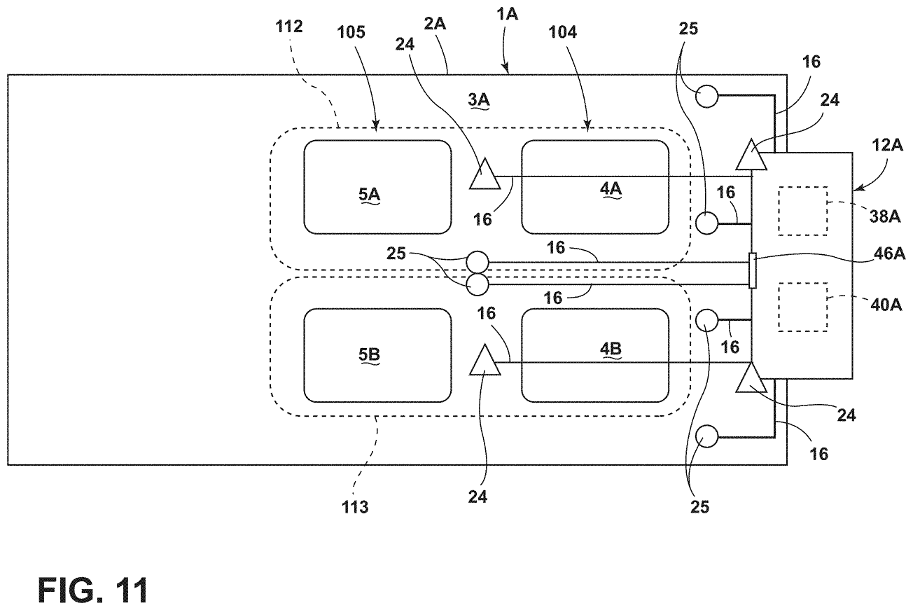

With further reference to FIG. 11, a vehicle 1A includes a vehicle body 2A and a passenger compartment 3A having a left climate zone 112 and a right climate zone 113. It will be understood that vehicle 1A may be substantially similar to vehicle 1 (FIG. 1). The left climate zone 112 includes left front seat 4A and left rear seat 5A, and the right climate zone 113 includes front right seat 4B and right rear seat 5B. The vehicle 1A of FIG. 11 may include a front HVAC system 12A that is similar to the front HVAC unit 12 described in more detail above in connection with FIGS. 1-9. However, vehicle 1A does not include an auxiliary console HVAC system 14. Thus, the front HVAC unit 12A is configured such that it does not include a functioning cold air outlet 45. Thus, although the front HVAC unit 12A may include a heating unit 38A and a cooling unit 40A that are substantially identical to the heating and cooling units 38 and 40, respectively, of the front HVAC unit 12 described in more detail above, front HVAC unit 12A may include a cold air outlet 45A that is blocked, or the auxiliary passageway 77A (FIG. 1A) may be closed off. It will be understood that the passageway 77 and evaporator core 89 (FIG. 1A) may be modified such that substantially all of the air 75 entering air inlet 74 passes through the evaporator core 89, heater core 76, and blend door 72 of FIG. 1A. In a preferred embodiment, the front HVAC unit 12A is substantially identical to the front HVAC unit 12 described above in connection with FIGS. 1-9 except that the cold air outlet 45A of front HVAC unit 12A is blocked or otherwise disabled. However, it will be understood that the present disclosure is not limited to this preferred embodiment.

Referring again to FIG. 11, the front HVAC unit 12A provides air to a plurality of floor outlets 24 and panel outlets 25 via air ducts 16. The front HVAC system 12A is configured to control the outlets 24 and 25 of first climate zone 112 substantially independently of the outlets 24 and 25 of second climate zone 113. Thus, the vehicle 1 or 1A of FIG. 11 includes a single front HVAC unit 12A that provides conditioned air in first and second climate zones 112 and 113 for both first row 104 and second row 105. The configuration of FIG. 11 does not include a console HVAC unit 140 and it also does not include an auxiliary climate system 110. Each climate zone may include a user input and/or a temperature sensor to provide individual temperature control for the climate zones.

With further reference to FIG. 12, vehicle 1A may include first, second, and third rows 104, 105, and 106, respectively, as discussed above in connection with FIG. 10. When configured as shown in FIG. 12, vehicle 1A includes a first (front) HVAC unit 12 and an auxiliary console system 140 having a dual zone PTC heating unit 142B that is configured to provide conditioned air to climate zones 118A-118C. The vehicle 1A of FIG. 12 further includes an auxiliary climate system 110 that is configured to provide conditioned air to a rear or third climate zone 118D.

The auxiliary climate system 110 may be substantially identical to the system described in U.S. patent application Ser. No. 16/360,773, and may include an evaporator and blower assembly 120 that supplies air to one or more floor outlets 24 and one or more panel outlets 25 located adjacent third row 106, behind second (intermediate) row 105. Evaporator and blower assembly 120 includes a blower 111 and an evaporator 89A (FIG. 14) that is operably connected to condenser 82 of front HVAC unit 12 by refrigerant lines 86A and 90A. The lines 86A and 90A may be routed above or below the floorboard as required for a particular application. If vehicle 1A includes a hybrid or internal combustion drive, the refrigerant lines 86A, 90A may be routed under the vehicle body (floor structure 30). If vehicle 1A comprises an electric vehicle, the refrigerant lines 86A, 90A may be routed along the outer perimeter of the vehicle underbody (floor structure 30) around the batteries 32. It will be understood that auxiliary climate system 110 may include a separate condenser (not shown) located in a rear portion of the vehicle 1A rather than being connected to condenser 82 of front HVAC unit 12. For example, a dedicated condenser for auxiliary climate system 110 may be positioned in a rear of vehicle 1A if it is impractical to route refrigerant lines 86A, 90A from front HVAC unit 12 to an auxiliary climate system 110 positioned in a rear portion of vehicle 1A. The auxiliary climate system 110 may include mode doors 116 that control (selectively split or block) the flow of air to the floor ducts 116 and panel outlets 24 and 25, respectively. The mode doors 116 may optionally comprise plenums as described in pending U.S. patent application Ser. No. 16/524,483, entitled “APPARATUS AND METHOD FOR CONTROLLING THE DISTRIBUTION OF AIR IN AN HVAC SYSTEM,” filed on Jul. 29, 2019, the entire contents of which are incorporated herein by reference.

The system of FIG. 12 may include user inputs 122A-122D corresponding to climate zones 118A-118D, respectively, to permit users to independently control the temperature of each climate zone 118A-118D. The user inputs 122A-122D may comprise, for example, thermostats that are operably connected to a controller 124 to thereby independently maintain the temperature of each climate zone 118A-118D. Controller 124 may comprise a “dedicated” control unit that is specifically configured to provide for climate control, or the controller 24 may comprise one or more controllers that are configured to control, at least in part, other vehicle functions. Thus, the term “controller” as used herein is not limited to a specific hardware or software configuration.

The multi-zone climate system of FIG. 12 may further include temperature sensors 126A-126E positioned in, or adjacent, each climate zone 118A-118E that are operably connected to the controller 124. Additional sensors (humidity, sun load, etc.) (not shown) may also be operably connected to the controller 124, and the controller 124 may be configured to determine discharge air temperatures that are required to bring each climate zone 118A-118E to the set temperatures for each climate zone. It will be understood that the temperature sensors 126A-126E are optional, and each user input 122A-122E may be configured to provide a set air discharge temperature (i.e. open loop control) based on a user setting. Furthermore, the multi-zone climate system of FIG. 12 may optionally include a combination of open and closed-loop control configurations whereby some of the zones 118A-118E have open loop control (i.e. no temperature sensor), and other zones have closed loop control, including a temperature sensor 126A-126E. In general, the temperature of each climate zone may be independently controlled.

With further reference to FIG. 13, vehicle 1A may be configured to include climate zones 118A-118D that are controlled in substantially the same manner as described above in connection with FIG. 12. However, when the multi-zone climate system of vehicle 1A is configured as shown in FIG. 13, the multi-zone climate system of vehicle 1A includes left and right third row climate zones 118E and 118F that are individually controlled by a dual zone auxiliary unit 110A. The auxiliary HVAC unit 110A may include first and second heater cores and zone mode doors for the zones 118E and 118F as described in U.S. patent application Ser. No. 16/360,773. The multi-zone climate system of FIG. 13 may optionally include user inputs 122E and 122F and optional temperature sensors 126E and 126F that are utilized to control the temperature of the air in the climate zones 118E and 118F.

The multi-zone climate system of vehicle 1A may also be configured as shown in FIG. 14. When configured according to FIG. 14, the multi-zone climate system includes third row zones 118E and 118F that are controlled by an auxiliary climate control system 110A in substantially the same manner as described above in connection with FIG. 13. The vehicle 1A of FIG. 14 further includes first and second front climate zones 118A and 118B, and a single second row climate zone 118C that is controlled by a single zone PTC unit 142A. Each climate zone may include a user input and/or a temperature sensor to provide individual temperature control (closed or open loop) for the climate zones.

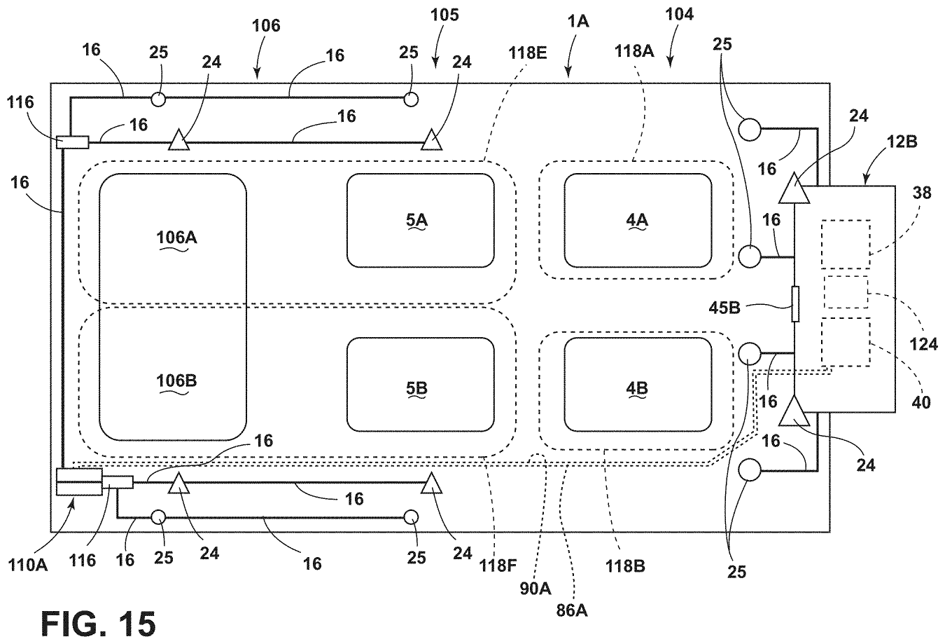

With further reference to FIG. 15, a vehicle 1A may include a multi-zone climate system including a front HVAC unit 12B that supplies conditioned air to front climate zones 118A and 118B of a front row 104. The front HVAC unit 12B may be substantially similar to the front HVAC unit 12A described above in connection with FIG. 11. However, when vehicle 1A is configured as shown in FIG. 15, the system does not include ducts 16 providing air to floor and/or panel outlets 24 and 25 of second row 105 from front HVAC unit 12B. Front HVAC unit 12B may not include a cold air duct, or it may include a blocked cold air duct 45B. When configured as shown in FIG. 15, an auxiliary climate system 110A includes a plurality of ducts 16 that route conditioned air to one or more floor outlets 24 and/or panel outlets 25 to supply conditioned air to left and right rear climate zones 118E and 118F, respectively. When configured in this way, the left rear climate zone 118E includes left second row seat 5A and third row left seating area 106A, and climate zone 118F includes second row right seat 5B and third row right seat or seating area 106B. The auxiliary climate system 110A comprises a dual zone system to provide independent control of the climate (temperature) of climate zones 118E and 118F. The auxiliary climate system 110A may be configured in substantially the same manner as discussed above in connection with FIG. 13, and in particular auxiliary climate system 110A may be configured as disclosed in U.S. patent application Ser. No. 16/360,773. Each climate zone may include a user input and/or a temperature sensor to provide individual temperature control (closed or open loop) for the climate zones.

With further reference to FIG. 16, a vehicle 100 according to another aspect of the present disclosure includes first, second, and third rows of seats 104, 105, and 106, respectively, forming a single climate zone 130. Vehicle 100 may comprise an autonomous vehicle having an electrically-powered drive system. Vehicle 100 may, alternatively, include an internal combustion drive, or a hybrid drive including one or more internal combustion engines and one or more electric motors. Vehicle 100 includes a front HVAC unit 12 that may be configured in substantially the same manner as the HVAC system 12 described in more detail above in connection with FIGS. 1-9. Vehicle 100 further includes a single zone PTC heater unit 142A. In the system of FIG. 16, PTC unit 142A supplies conditioned air to side air outlets 136A and 136B via a first duct 133 that is fluidly connected to transversely-extending ducts 134. Air outlets 136 may be configured to direct air onto one or more side windows 138A, 138B, 138C (see also FIG. 10). The air outlets 136 may comprise “demist outlets” that are configured to defrost or defog one or more of the side windows of vehicle 100. Alternatively, a dual zone PTC heater unit 142B may be utilized such that air supplied to air outlets 136A and 136B may be at different temperatures. It will be understood that separate ducts 133 (not shown) may be utilized to supply air at different temperatures to the air outlets 136A and 136B if a dual zone PTC heater 142B is used.

It will be understood that the console HVAC system 140 of FIGS. 10-16 may comprise a liquid-to-air heat exchanger as described above in connection with FIGS. 1-9 rather than the PTC (electric-to-air) heaters of FIGS. 10A and 10B.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle having a passenger compartment with a front row of seats defining first and second front climate zones, a second row of seats behind the front row of seats defining at least one intermediate climate zone, and a third row of seats behind the second row of seats defining at least one rear climate zone, the vehicle further comprising:
a front HVAC unit mounted in a forward portion of the vehicle and including front air outlets that are configured to provide heated and cooled air to the first and second front climate zones, and wherein the front HVAC unit further includes a cold air outlet;
an electrically-powered Positive Thermal Coefficient (PTC) heater connected to the cold air outlet of the front HVAC unit, the electrically-powered PTC heater including an electricity-to-air heat exchanger configured to selectively heat cold air entering the electrically-powered PTC heater, and wherein the electrically-powered PTC heater includes a heat control system that is configured to control a temperature of air exiting the electrically-powered PTC heater, the electrically-powered PTC heater further including at least one air outlet configured to supply heated air from the electrically-powered PTC heater to the at least one intermediate climate zone of the passenger compartment;
an auxiliary climate control system configured to selectively heat and cool air exiting one or more air outlets positioned behind the intermediate climate zone in the rear climate zone, the auxiliary climate control system including an auxiliary heater core and an auxiliary evaporator, wherein the auxiliary heater core and the auxiliary evaporator are both positioned behind the intermediate row.

2. The vehicle of claim 1, wherein:
the auxiliary heater core includes first and second zones that are configured to supply conditioned air to first and second portions of the rear climate zone.

3. The vehicle of claim 2, wherein:
the auxiliary climate control system includes a first mode door downstream from the first zone of the auxiliary heater core, and a second mode door downstream from the second zone of the auxiliary heater core.

4. The vehicle of claim 3, wherein:
the auxiliary climate control system includes a blower configured to force air through the auxiliary evaporator and through the auxiliary heater core toward the first mode door and the second mode door.

5. The vehicle of claim 1, including:
a powered blower operably connected to the cold air outlet and positioned in a center console of the vehicle behind the front HVAC unit.

6. The vehicle of claim 5, including:
the heat control system of the electrically-powered PTC heater controls electric current to the electricity-to-air heat exchanger to control the temperature of air exiting the PTC heater.

7. The vehicle of claim 6, wherein:
the intermediate climate zone includes first and second intermediate climate zones, and the electricity-to-air heat exchanger of the electrically-powered PTC heater includes first and second zones that separately heat air supplied to the first and second intermediate climate zones, respectively.

8. The vehicle of claim 7, including:
a plenum operably connected to the electrically-powered PTC heater to control flow of air to a panel outlet and a floor outlet.

9. The vehicle of claim 8, wherein:
the electrically-powered PTC heater is positioned in the center console rearward of the powered blower.

10. The vehicle of claim 1, wherein:
the vehicle comprises an electrically powered vehicle, and including:
a high voltage traction battery positioned below a center console of the vehicle.

11. A vehicle having a passenger compartment defining at least first, second, and third rows of seats, the vehicle including a climate control system comprising:
a front HVAC unit configured to be mounted in a forward portion of a vehicle, wherein the front HVAC unit is configured to provide conditioned air to the first row of seats, the front HVAC unit further including a cold air outlet that provides only cold air;
a powered blower operably connected to the cold air outlet;
an electrically-powered heater including an electricity-to-air heat exchanger positioned in a console of the vehicle and connected to the cold air outlet of the front HVAC unit whereby cold air from the cold air outlet passes through the electrically-powered heater;
left and right ducts extending from the electricity-to-air heat exchanger of the electrically-powered PTC heater;
left and right air outlets positioned behind the first row of seats and connected to the left and right ducts and distributing air to left and right side portions of the passenger compartment behind the first row of seats;
an auxiliary climate control system configured to selectively heat and cool air exiting one or more air outlets positioned in a rear portion of the vehicle behind the first row, the auxiliary climate control system including an auxiliary heater core and an auxiliary evaporator, wherein the auxiliary heater core and the auxiliary evaporator are both mounted behind the second row of seats.

12. The vehicle of claim 11, wherein:
the left and right air outlets are configured to direct air from the left and right ducts onto inner surfaces of left and right windows of the vehicle behind the first row.

13. The vehicle of claim 12, wherein:
the auxiliary climate control system includes ducts extending to air outlets positioned adjacent the second row of seats and to air outlets positioned adjacent the third row of seats.

14. The vehicle of claim 13, wherein:
the first, second, and third rows of seats comprise a single climate zone, and the climate control system is configured to maintain a substantially uniform air temperature throughout the single climate zone.

15. The vehicle of claim 14, including:
at least one mode door operably connected to the auxiliary heater core to control flow of air from the one or more air outlets to at least one panel outlet and to at least one floor outlet located in a rear portion of the vehicle behind the first row.

16. The vehicle claim 14, wherein:
the electrically-powered heater comprises a PTC heater.

17. A method of controlling air temperature in multiple zones of a passenger compartment of a motor vehicle, the method comprising:
utilizing a front HVAC unit to provide independently-controlled conditioned air to first and second front zones of the passenger compartment;
causing cold air from the front HVAC unit to flow rearwardly through a center console of the motor vehicle to an electrically-powered heater disposed in the center console;
using an electricity-to-air heat exchanger of the electrically-powered heater to heat the cold air from the front HVAC unit;
distributing air that has been heated by the electricity-to-air heat exchanger to a first rear zone of the passenger compartment that is located behind the first and second front zones of the passenger compartment;
utilizing an auxiliary climate control system having an auxiliary heater core and an auxiliary evaporator located behind the first rear zone to supply conditioned air to a second rear zone that is located behind the first rear zone.

18. The method of claim 17, including:
causing cold air exiting the front HVAC unit to be distributed to the first rear zone without further cooling of the cold air after the cold air has exited the front HVAC unit.

19. The method of claim 17, including:
utilizing a single zone PTC heater having an electricity-to-air heat exchanger disposed in the center console to heat cold air from the front HVAC unit.

20. The method of claim 17, including:
utilizing a dual zone PTC heater having a dual zone electricity-to-air heat exchanger disposed in the center console to independently heat cold air from the front HVAC unit to form first and second streams of conditioned air that are separated by a divider.
